(19) United States
(12) Patent Application Publication
(10) Pub. No.: US 2024/0316726 A1
(43) Pub. Date: Sep. 26, 2024

(54) KNIFE SHARPENING DEVICE, AND KNIFE REPLACEMENT METHOD AND SYSTEM

(71) Applicant: Mundial INC., Davie, FL (US)

(72) Inventor: Michael Lenn Ceitlin, São Paulo (BR)

(73) Assignee: Mundial INC., Davie, FL (US)

(21) Appl. No.: 18/575,486

(22) PCT Filed: Apr. 29, 2022
(86) PCT No.: PCT/BR2022/050144

§ 371 Date: Dec. 29, 2023

(30) Foreign Application Priority Data
Jun. 29, 2021 (BR) BR102021012926-3

(51) Int. Cl. B24B 55/00; B24B 3/54

(52) U.S. Cl. CPC B24B 55/00; B24B 3/54

(57) ABSTRACT

This invention refers to a knife sharpening device (200), a knife replacement method and a knife replacement system (100). The knife sharpening device (200) comprises a control board (212) configured to connect an external network to the sharpening device (200). The method comprises the steps of: obtaining knife durability parameters (1002); obtain knife use information (1004); and defining compliance check data (1006). The knife replacement system (100) comprises the knife sharpening device (200) and a server (300) configured to obtaining knife durability parameters, obtain knife use information, and compare the knife use information with the knife durability parameters.

This invention refers to a knife sharpening device, a knife replacement method, and a knife replacement system for replacing knives whose characteristics are non-compliant with the desired standards, due to their use and wear down.

### DESCRIPTION OF THE STATE OF THE ART

The use of cutting utensils in restaurants, cold storage facilities, homes, etc. is a practice that requires care, with constant maintenance of the utensil used. A cutting utensil, such as a knife, for example, requires special attention when used very frequently. Characteristics related to the use, wear down and model of these utensils must be taken into consideration, in order to ensure that replacement takes place at a suitable time. Replacing a knife at the right time may result in countless benefits, for both the knife user and the person in charge of the knife replacement.

At the state of the art, several systems have been developed in order to obtain different types of utensil use data. Such systems at the state of the art are designed to automatically collect information that can help with monitoring professional staff, sanitizing equipment, and optimizing processes, among others. These data are sent to a network that interconnects civil devices, and with a central server.

One example of a system for collecting data from home devices through an IP network is described in document U.S. Pat. No. 7,403,982. This document describes a method for controlling home machines and utensils connected to an IP network that allowed such communication and exchange of information among the above-mentioned devices, while also allowing control of such devices through a central control element that is also connected to the IP network.

Another example of a document at the state of the art that describes the use of data obtained from devices connected to utensils is document U.S. Pat. No. 6,867,698. In this case, a system and a method are described for obtaining data related to the use of a device. When passing the utensil through a defined region, such as a utensil sterilizer, for example, the system collects information related to utensil hygiene, and warns the user that the utensil needs sanitization, or that the utensil was sanitized in an inadequate manner.

A third example, document US 2014/0320267 describes a food cutting device that can transmit and/or store information on a rotating blade. The blade comprises a transceiver that transmits this information in response to a radio request. The information is sent to a radio transponder that stores it. The information includes blade use data.

However, the state of the art does not describe a suitable way of monitoring knife use in order to suggest replacement at the most appropriate time. For example, and knife that is frequently used must be substituted replaced through the use of a defined set of parameters. These parameters may be defined in different ways, such as based on the life model, the knife use characteristics, the data collected from a plurality of knives with similar characteristics, etc.

The documents at the state of the art also do not describe an efficient way of defining these parameters, and a way of constantly updating such parameters. Replacement at the right time through comparing knife use with parameters defined frequently and in an accurate manner may result in countless benefits, such as enhanced efficiency, fewer user injuries, and lower costs, for example.

### Purposes of the Invention

In view of the problems described at the state of the art, the purpose of this invention is to provide a method and a knife replacement system that collects information related to knife use and compared this against durability parameters, in order to define the right time for replacing a knife in use.

Another purpose of this invention is to allow updates of the durability parameters in real time or with a defined frequency, in order to constantly optimize the right knife replacement time. Such updates may be based on data collected from a plurality of knives in use, for example, or else from the tests performed on knives.

Furthermore, one purpose of this invention is to provide a method and a knife replacement system that provides gains in efficiency for the knife user by suggesting replacement and/or replacing the knife at the right time, lowering costs by avoiding unnecessary replacements and with fewer user injuries, by suggesting replacement and/or replacing the knife when such replacement is necessary.

Additionally, the purpose of this invention is to provide a knife sharpening device that can collect the necessary knife use information and connect to a network in order to provide gains in efficiency for the knife user by suggesting replacement and/or replacing the knife at the right time, lowering costs by avoiding unnecessary replacements and with fewer user injuries, by suggesting replacement and/or replacing the knife when such replacement is necessary.

### BRIEF DESCRIPTION OF THE INVENTION

The present invention relates to a knife sharpening device that comprises: an sharpening device body; an motor attached to the sharpening device body; an grinding wheel associated with the motor; sharpening guides attached to the sharpening device body and positioned alongside the grinding wheel; an control board connected to the motor; and an communication antenna comprised of and in communication with the control board, wherein the control board is configured to connect an external network to the sharpening device, wherein the control board is configured to obtain device use information through the activation of the motor and knife use information through the communication antenna, whereby the control board sends the obtained knife use information to an external server if the control board is connected to the external network, wherein the control board stores the obtained knife use information if the control board is not connected to the external network, and wherein the knife use information comprises at least one of: the knife use duration and number of knife sharpening operations.

Optionally, the knife sharpening device also comprises a signaling element connected to the control board, wherein the signaling element is configured to receive the device use information from the control board and provide a user with the device use information, wherein the device use information comprises at least one from among: a connection of the device to an energy source, a connection between the device and an external network, an internal problem with device components, collecting the knife use information, sending the knife use information to the server and activation of the device by the user through the external server.

Optionally, the control board is configured to store usage limits offline and halt the operations of the knife sharpening device should offline usage limit situations occur, wherein the offline usage limit situations occur when the knife sharpening device remains unconnected from the external network for a period of time longer than that defined in the offline usage limits or as from a number of sharpening operations higher than that defined in the offline usage limits.

Optionally, the offline usage limit situations occur when the knife sharpening device remains unconnected from the external network for a period of time longer than 30 (thirty) days, or when the knife sharpening device remains unconnected from the external network for more 4,000 (four thousand) sharpening operations.

The present invention relates to a knife replacement method that comprises the steps of: obtaining knife durability parameters, wherein the knife durability parameters comprise at least one from among: useful knife life duration and the maximum number of knife sharpening operations; obtain knife use information, wherein the knife use information comprises at least one from among: knife use duration and a number of knife sharpening operations; defining compliance check data, wherein defining the compliance check data comprises comparing the knife use information with the knife durability parameters in order to define whether the knife use information is compliant with the knife durability parameters, or whether the knife use information is non-compliant with the knife durability parameters; and replacing the knife with a replacement knife, should the knife use information present values not compliant with the knife durability parameter values.

Optionally, the step of defining the knife durability parameters takes place on a daily basis.

Optionally, the knife durability parameters are adjusted by the parameter adjustment information, wherein the parameter adjustment information is generated through the difference between the knife use information on previous sharpening operations, and the knife durability parameters.

Optionally, the knife replacement method also comprises a step of notifying a user of the knife replacement with a replacement knife.

The present invention relates to a knife replacement system that comprises a knife sharpening device; and a server configured to obtain knife durability parameters, whereby the knife durability parameters are defined periodically according to the knife model, and wherein the knife durability parameters comprise at least one from among: useful knife life duration and the maximum number of knife sharpening operations; wherein the server is configured to obtain knife use information from the knife sharpening device, wherein the knife use information comprises at least one knife use duration and a number of knife sharpening operations, compare the knife use information with the knife durability parameters; and suggest the knife replacement with a replacement knife, should the knife use information present values not compliant with the knife durability parameter values.

Optionally, the definition of the knife durability parameters takes place on a daily basis.

Optionally, the knife durability parameters are adjusted by the parameter adjustment information, wherein the parameter adjustment information is generated through the difference between the knife use information and the knife durability parameters from previous sharpening operations.

### BRIEF DESCRIPTION OF THE DRAWINGS

This invention is described in greater detail below, based on an example of an embodiment shown in the drawings. the Figures show:

FIG. 1 is a perspective view of an embodiment of the knife sharpening device of the present invention;

FIG. 2 is a perspective view of an embodiment of the knife sharpening device of the present invention;

FIG. 3 is an exploded view of an embodiment of the knife sharpening device of the present invention;

FIG. 4 is an exploded view of an embodiment of the knife sharpening device of the present invention;

FIG. 5 is a schematic diagram of an embodiment of the knife replacement system of the present invention;

FIG. 6 is a schematic diagram of an embodiment of the knife replacement system of the present invention;

FIG. 7 is a schematic diagram of an embodiment of the knife replacement system of the present invention;

FIG. 8 is a schematic diagram of an embodiment of the knife replacement system of the present invention;

FIG. 9 is a schematic diagram of an embodiment of the knife replacement system of the present invention;

FIG. 10 is a schematic diagram of an embodiment of the knife replacement system of the present invention;

FIG. 11 is a schematic diagram of an embodiment of the knife replacement system of the present invention;

FIG. 12 is a sequence de steps de an embodiment of the knife replacement method of the present invention.

### DETAILED DESCRIPTION OF THE DRAWINGS

Initially, it must be noted that the term “preferred” and its variations used in this text may not be understood as imperative or mandatory, but should be understood only as indicating an optional and particularly desirable configuration of this invention.

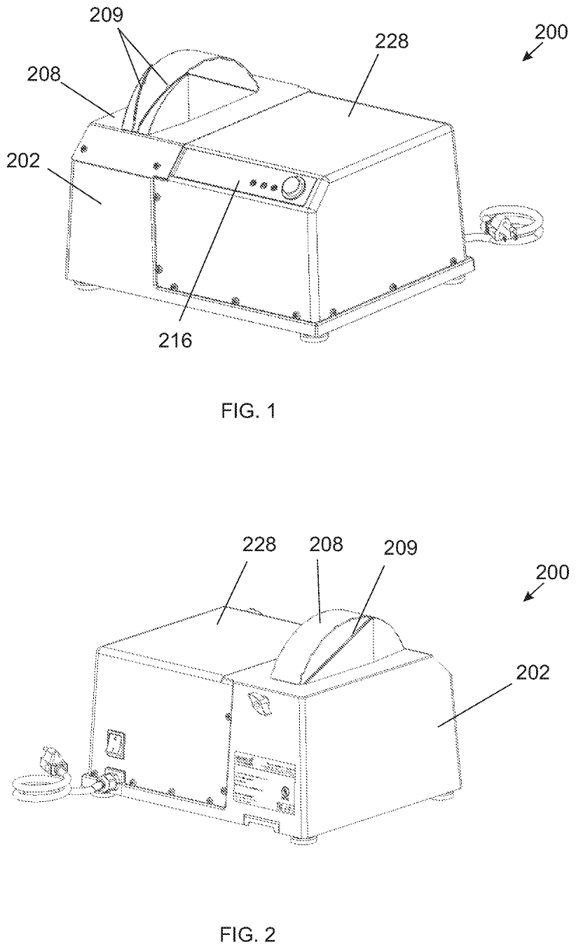

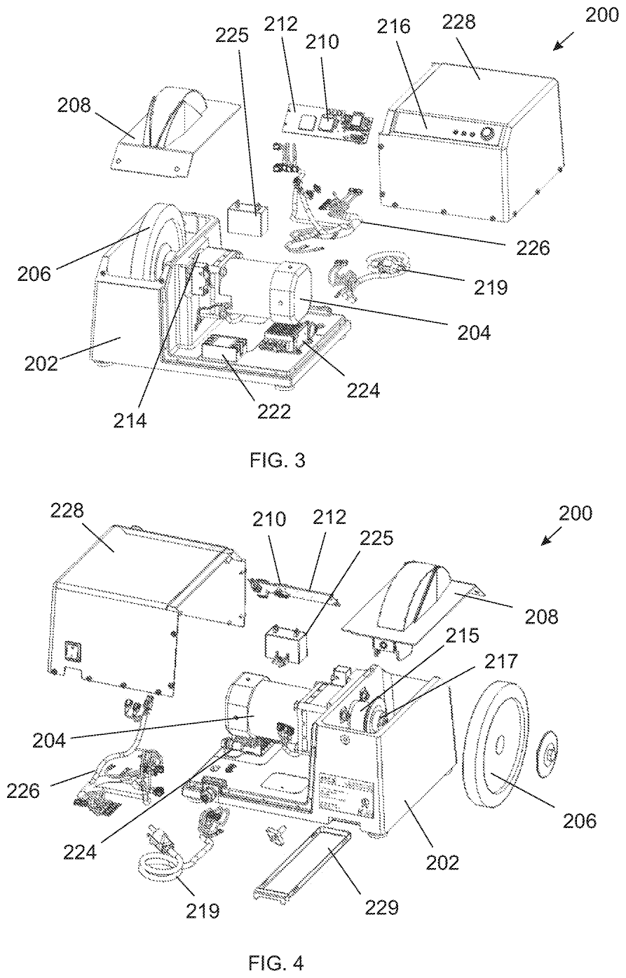

FIGS. 1, 2, 3, and 4 illustrate the knife sharpening device 200 of the present invention according to a preferred embodiment. In this embodiment, the knife sharpening device 200 comprises a sharpening device body 202, a motor 204, a grinding wheel 206, a grinding wheel cover 208 with sharpening guides 209, a communication antenna 210, and a control board 212. FIGS. 3 and 4 illustrate the knife sharpening device 200 shown in FIGS. 1 and 2 in exploded views, for easier visualization of the internal elements of the knife sharpening device 200.

The motor 204 is associated with the sharpening device body 202 through a bearing assembly 214 that comprises a bearing 215 and an axle 217. The motor 204 may be any type of motor with characteristics that allowed to be associated with the sharpening device body 202 through the bearing assembly 214, such as, for example, an alternating current (AC) motor.

The grinding wheel 206 is a disc-shaped element that comprises an abrasive material that sharpens the cutting utensils. In this embodiment, the grinding wheel 206 is associated with the motor 204 through the axle 217 of the bearing assembly 214. Consequently, the drive of the motor 204 turns the axle 217 and consequently the grinding wheel 206, whereby a sharpening operation is performed on a cutting utensil, such as a knife, for example.

The sharpening guides 209 are grooves formed in the grinding wheel cover 208. The grinding wheel cover 208 is a protective element that slots onto the sharpening device body 202 and is positioned alongside the grinding wheel 206. The purpose of the grinding wheel cover 208 enhance the safety of the device by preventing undesirable physical contact between the user and the grinding wheel 206 during a sharpening operation. The sharpening guides 209 encompassed by the grinding wheel cover 208 are grooves run across the grinding wheel cover 208 and allow the knife to come into contact with the grinding wheel 206 without allowing any contact between the user and the grinding wheel 206.

The sharpening guides 209 are set at an angle to the longitudinal vertical plane of the grinding wheel cover 208. Consequently, when moving the knife close to the grinding wheel 206 during sharpening, the knife comes into contact with the grinding wheel 206 in an inclined manner. In this embodiment, the angles of the sharpening guides 209 with relation to the longitudinal vertical plane of the grinding wheel cover 208 are fixed and predefined, according to the project design. However, sharpening guides 209 with variable angles may be used, in an alternative embodiment of this invention.

The communication antenna 210 is an automatic identification element that obtains information on the knife during the sharpening operation. in the preferred embodiment, the communication antenna 210 is an RFID (radio frequency identification) antenna. However, other types of antennas or other means of communication may be used to obtain information related to the use of the knife during the sharpening operation.

The RFID antenna 210 is mounted on the knife sharpening device 200, more specifically on the control board 212, and obtains knife use information during the knife sharpening operation. Hence, whenever the user uses the knife sharpening device 200 to sharpen the knife, this comprises an RFID ticket configured to interact with this invention, and the RFID antenna 210 will obtain the knife use information.

The knife use information is information related to the use of the knife that helps make decisions on whether or not to replace the knife. In a preferred embodiment, the knife use information comprises at least one of: the knife use duration and number of knife sharpening operations.

The knife use duration is the total lifetime of the knife in use. In other words, it is the length of time during which the knife is in use by a user. This characteristic is important for deciding when the knife must be replaced, as the knife wears out over time. When reaching a defined length of time in use, the wear down on the knife and other factors that adversely affect the correct use of the knife become more marked. At that time, knife replacement becomes necessary, in order to avoid problems, such as loss of efficiency and user injuries.

In turn, the number of knife sharpening operations is also relevant for the efficiency and safety in use of the knife. The number of knife sharpening operations corresponds to the number of times that the knife was placed in contact with the grinding wheel in order to sharpen it. The more times the knife is sharpened, the more it is subject to wear down. Hence, when reaching a defined number of sharpening operations, the knife must be replaced, in order to avoid loss of efficiency and user injuries.

Additionally, the RFID antenna 210 is configured to obtain additional information on the knife. The additional information on the knife is information that includes at least one from among the following information: knife series number, knife fabrication date and place, and knife sharpening date. This date information is obtained through the RFID antenna 210 during the sharpening of the knife on the knife sharpening device.

The knife series number is a numbering that allows the knife sharpening device to identify each knife being sharpened. This information is associated with a user. Consequently, the knife sharpening device can identify the user performing a specific sharpening operation. An advantage of identifying the user using a knife and sharpening this knife is obtaining a higher level of individualization in the information analysis, as it is possible to define whether a specific user is performing more sharpening operations than the others, based on the knife series number, or whether the person is using the knife improperly by not sharpening it with the necessary frequency.

In addition to the knife use information and the additional information on the knife, other information may be used by the knife sharpening device of the present invention to ensure that the knife replacement will be undertaken at the proper time. A replacement before it is necessary will lead to unnecessary replacement costs, while a delayed replacement will result in a loss of efficiency and possible user injuries.

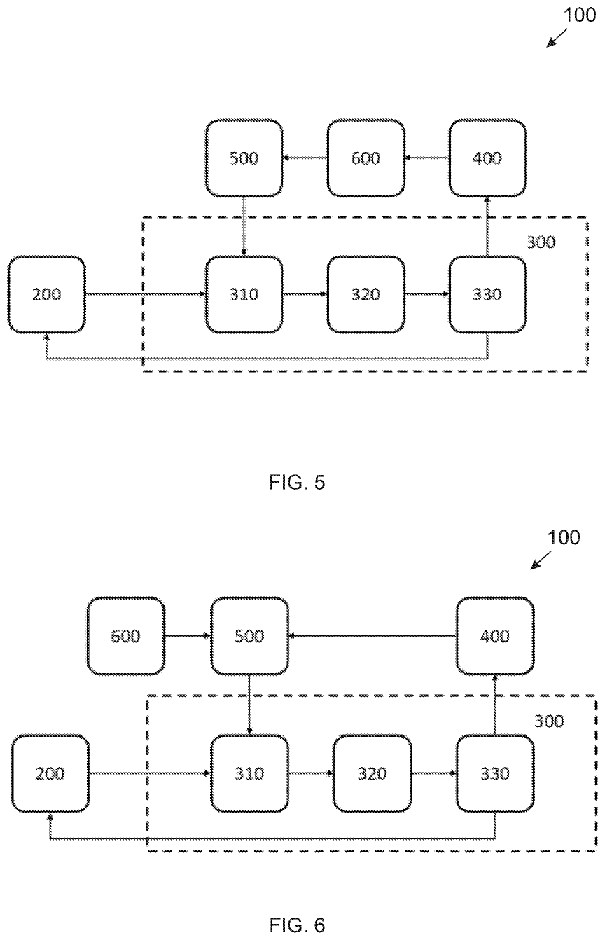

The knife use information and the additional information on the knife obtained through the RFID antenna 210 are sent to the control board 212. The control board 212 is the component of the knife sharpening device 200 that obtains the knife use information and sends this information to a server 300 (which will be described in detail below in FIG. 5). To do so, the control board 212 must be connected to a network that allows information transmission. Consequently, the control board 212 can connect external networks to the knife sharpening device 200, such as a wireless (Wi-Fi) network, for example, which provides Internet access to the knife sharpening device 200 and allows the knife sharpening device 200 to connect to the external server 300.

Although described as connected to a Wi-fi network, the control board 212 can connect to the server 300 through different types of networks. In one configuration, the control board 212 connects to a mobile device, which functions as a server through a local connection, such as a Bluetooth connection, for example. In this embodiment, by positioning the mobile device close to the control board 212, information can be transferred between the knife sharpening device 200 and the mobile device. The alternative embodiments described below for connecting the knife sharpening device 200 to server 300 must also be understood as including possible variants of the server, in addition to the use of other types of connections, such as a Bluetooth connection, for example.

The control board 212 is also configured to store the knife use information and the additional information on the knife obtained through the RFID antenna 210. For example, in one embodiment, the control board 212 cannot connect to the external network, or when the external network is not available, the control board 212 stores the knife use information and the additional information obtained on the knife. This stored information may be sent subsequently to the server 300 when the connection with the external network becomes available. Hence, in the preferred configuration, the control board 212 sends the knife use information and the additional information obtained on the knife to an external server 300, if the control board 212 is connected to the external network and stores the knife use information and the additional information obtained on the knife, if the control board 212 is not connected to the external network.

The control board 212 is also configured to obtain device use information and store it and/or send it to the external server 300. The device use information is information related to the use of the knife sharpening device 200 and comprises at least one from among: connection of the knife sharpening device 200 to an energy source, connection of the knife sharpening device 200 to the external network, internal problem with components of the knife sharpening device 200, collecting the use information, sending the knife use information to the server 300 and activation of the knife sharpening device 200 by the user through the external server 300. This device use information allows the user to understand possible problems that might be occurring with the knife sharpening device 200, such as no connection with the network, for example, and increase the amount of information sent to the server 300. Consequently, user experience and replacement efficiency are improved.

The control board 212 is also configured to store usage limits offline and halt the operations of the knife sharpening device 200 should offline usage limit situations occur. The offline usage limit situations occur when the knife sharpening device remains unconnected from an external network for a period of time longer than that defined in the offline usage limits or as from a number of sharpening operations higher than that defined in the offline usage limits. In a preferred embodiment, the offline usage limit situations occur when the knife sharpening device remains unconnected from the external network for a period of time longer than 30 (thirty) days, or when the knife sharpening device remains unconnected from the external network for more 4,000 (four thousand) sharpening operations. In alternative configurations, these values may be altered, in order to comply with project design specifications.

In the preferred configuration, the knife sharpening device 200 comprises and signaling element 216. The signaling element 216 is connected to the control board 212 and is configured to obtain the device use information from the control board 212. The signaling element 216 provides the user with information on the use of the device. In the preferred configuration, the supply of device use information to the user is handled through visual media, such as different colored lights arrayed on the signaling element 216, for example. Alternatively, other means of supplying information may be used, such as psalms and graphic displays.

In the preferred configuration, the knife sharpening device 200 also comprises an electricity source 224, a solid-state relay 222, a capacitor 225, a wire harness 226, a cowling cover 228, a tray 229 and a power cable 219. The wire harness 226 connects the internal elements of the knife sharpening device 200, such as the control board 212, the motor 204, the RFID antenna 210, the electricity source 224, and the solid-state relay 222. The solid-state relay 222 switches the power on and off for the motor, through a signal obtained from the control board 212. The electricity source 224 provides electricity to the internal components of the knife sharpening device 200. The cowling cover 228 protects the internal components of the knife sharpening device 200 and is configured to slot onto the body of the device.

In an alternative configuration of the knife sharpening device 200 of the present invention, instead of the solid-state relay 222, the knife sharpening device 200 comprises a driver for controlling the motor 204 that, in this alternative embodiment, is a continuous current DC motor 204 de.

FIG. 5 presents a schematic diagram of the knife replacement system 100 of the present invention according to a preferred embodiment. The knife replacement system 100 comprises the knife sharpening device 200 already described and the server 300, wherein the knife sharpening device 200 and the server 300 are configured to intercommunicate through the network to which the control board 212 is connected although illustrating a knife sharpening device 200 and a server 300 in the preferred embodiment, in another embodiment the knife replacement system 100 comprises at least one among a plurality of knife sharpening devices 200 and/or a plurality of servers 300, as will be described in detail below.

One of the functions of the server 300 is to obtain information on knife use and knife durability parameters, process this information and feed back compliance check data. The compliance check data comprises information indicating whether the knife use information is compliant with the knife durability parameters, or whether the knife use information is non-compliant with the knife durability parameters. The knife use information is compliant with the knife durability parameters when ceiling values of the knife durability parameters are not exceeded by the knife use information values. The knife use information is non-compliant with the knife durability parameters when ceiling values of the knife durability parameters are exceeded by the knife use information values.

When the compliance check data indicates that the knife use information values are not compliant with the knife durability parameter values, the server 300 is configured to suggest to the user that the knife be replaced with a replacement knife.

The knife durability parameters are information related to the knife use limits, being monitored through this invention, and used to accurately define the best moment for replacing each knife.

In a preferred embodiment, the knife durability parameters are defined periodically. In one example of this embodiment, the definition of the knife durability parameters takes place on a daily basis. In this case, the knife durability parameters are updated daily in the server 300, whereby knife monitoring activities are constantly developing, in terms of efficiency and accuracy.

In a preferred embodiment, the knife durability parameters comprise at least one from among: useful knife life duration, the maximum number of knife sharpening operations, or a combination of these characteristics.

The useful knife life duration is a knife durability parameter that defines the maximum length of time for the knife to develop an acceptable level of wear down; in other words, for how long the knife may be used until its physical characteristics start to undermine the correct use of the knife and jeopardize the physical integrity of the user. When exceeding the useful knife life duration, the knife must be replaced.

The maximum number of knife sharpening operations is a knife durability parameter that defines how many times a knife may be sharpened until it must be replaced. When the maximum number of sharpening operations is exceeded, the knife is subject to wear down that may result in a loss of efficiency for the use of the knife or even user injuries. In this case, the knife must be replaced.

The server 300 of the knife replacement system 100 of the present invention comprises an information receipt and storage unit 310, an information processing unit 320, and an information supply unit 330.

The receipt and storage unit 310 is a component of the server 300 configured to obtain information from sources external to the server 300 and stole them for subsequent use by the processing unit 320. To do so, the receipt and storage unit 310 is connected to the processing unit 320 to which it sends the information to be processed.

The receipt and storage unit 310 is also connected to the knife sharpening device. Consequently, the server 300 receives and stores information from the knife sharpening device through the receipt and storage unit 310. This information received by the receipt and storage unit 310 is stored in the receipt and storage unit 310 and may be used by the processing unit 320 when the server 300 needs to process some information. The information supplied by the knife sharpening device to the receipt and storage unit 310 includes at least one from among: the knife use information, the additional information on the knife, the device use information and/or the grinding wheel information.

Furthermore, the receipt and storage unit 310 is connected to parameters supply unit 500. The parameters supply unit 500 is the component of the system that obtains, stores, and supplies the knife durability parameters. The parameters supply unit 500 is configured to obtain the knife durability parameters from one or more sources, individually or in combination, store the knife durability parameters and supply the knife durability parameters to the receipt and storage unit 310.

Among the sources that provide the knife durability parameters choose parameters supply unit 500 is the manual insertion of the parameters by an operator 600 directly into the parameters supply unit 500.

The knife durability parameters are defined from at least one of: the knife model and the type of abrasive used in the sharpening operation.

The knife model is used to define the knife durability parameters, as each knife model is endowed with characteristics that differ from other models, such as the material used, the height of the knife body, and the length of the knife, for example. Consequently, each knife model has a duration for the useful life of a knife and a maximum number of specific knife sharpening operations. The useful knife life duration and the maximum number of knife sharpening operations are parameters defined through durability tests. these tests are conducted by the knife manufacturer, for example and serve as a basis for defining the standard knife durability parameters for each knife model.

Described below is an example of how the knife durability parameters are obtained from the characteristics of a knife model. This example describes how the durability parameters are obtained for a knife model with a length between approximately 15 centimeters and 35 centimeters, or more specifically, a length between approximately 20 centimeters and 30 centimeters, or else approximately 25 centimeters in length. In this case, after wear down occurs on the knife, the performance of its main functions is adversely affected. In this example, the wear down of the knife indicates that the knife must be replaced when the knife is worn away by between approximately 20% and 40%, or more specifically, between approximately 25% and 35%, or else approximately 30% of its cutting blade, measured from the handle up to between approximately 3 centimeters and 13 centimeters or more specifically, between approximately 5 centimeters and 11 centimeters, or else approximately 8 centimeters towards the tip of the knife. This wear down transforms the initial contour of the blade and makes the cutting area very thick, with adverse effects on the cutting and sharpening operations.

The type of abrasive on the grinding wheel used for sharpening is used to define the knife durability parameters, as this affects the amount of material removed from the body of the knife being sharpened, and thus has an impact on the durability of the knife. Consequently, the type of abrasive used in the sharpening operation affects the knife durability parameters. in an example of how the type of abrasive affects knife durability, the ceiling number of sharpening operations increases as the grinding wheel grain size diminishes. In other words, for the same knife model, the parameters also vary according to the type of abrasive used, as the type of abrasive alters the level of wear down on the knife material

In the preferred embodiment, the type of abrasive is defined from the information supplied by the user to the receipt and storage unit 310. Hence, the user inserts the type of abrasive used in the sharpening operation directly into the server To do so, the receipt and storage unit 310 is configured to receive information from the user on the type of abrasive used in the sharpening operation. The type of abrasive is information defined by the grinding wheel grain size and indicates the amount of material removed from the knife during the sharpening operation. Hence, this information is used to define how many sharpening operations a knife can withstand on that grinding wheel. The type of abrasive is used to enhance the accuracy of the right time to replace the knife in use.

The type of abrasive comprises a set of information called the grinding wheel information. In addition to the type of abrasive used on the grinding wheel, the grinding wheel information also includes information on how long the grinding wheel has been in use, and the number of sharpening operations performed by the grinding wheel. The length of time that the grinding wheel has been in use is the total time that the grinding wheel has been in use, and the number of sharpening operations performed by the grinding wheel is the number of times that the grinding wheel performed a sharpening operation.

The length of time for which the grinding wheel has been in news, and the number of sharpening operations performed by the grinding wheel is defined in the server, based on the knife use information obtained by the server from the knife sharpening device. The insertion by the user of the type of abrasive used, the number of sharpening operations performed by the device, and the length of time the device has been in use allow the definition of these values from the grinding wheel information.

The length of time that the grinding wheel has been in use, and the number of sharpening operations performed by the grinding wheel is information that ensures that the right moment is selected for the replacement of the grinding wheel. Consequently, in addition to defining the right moment for the knife replacement, the knife sharpening device of the present invention can also define the right moment to replace the grinding wheel.

The operator 600 providing the knife durability parameters may not be understood in a limiting manner. The operator 600 may be an entity in charge of performing durability tests on the knife models, as well as the knife user, comprising information that defines the knife durability parameters. The operator 600 may also be a computerized unit that stores the knife durability parameters and supplies them to the receipt and storage unit 310.

When information must be processed, the receipt and storage unit 310 sends the stored information to the processing unit 320. The processing unit 320 is a component of the server 300 configured to obtain information from the receipt and storage unit 310 and process this information through a logic included in the processing unit 320.

The logic included in the processing unit 320 is a logic programmed to compare the knife use information with the knife durability parameters and defining the compliance check data in other words, whether the knife use information is compliant with the knife durability parameters, or whether the knife use information is non-compliant with the knife durability parameters.

In the preferred embodiment, in order to define whether the knife use information is non-compliant with the knife durability parameters, the logic compares the knife use duration with the useful knife life duration, and the number of knife sharpening operations with the maximum number of knife sharpening operations. Should the knife use duration exceed the useful knife life duration, the knife use information is non-compliant with the knife durability parameters. Should the number of knife sharpening operations exceed the maximum number of knife sharpening operations, the knife use information is non-compliant with the knife durability parameters. Should the knife use duration be shorter than the useful knife life duration and the number of knife sharpening operations be fewer than the maximum number of knife sharpening operations, the knife use information is compliant with the knife durability parameters.

When the knife use information is non-compliant with the knife durability parameters, different adverse effects on the user may be noted, as already mentioned, these adverse effects include, for example, less efficient use of the knife, difficulty in handling the knife correctly, user injuries, and risk to the physical integrity of the user.

In addition to being connected to the receipt and storage unit 310, the processing unit 320 is connected to the supply unit 330. The supply unit 330 is configured to obtain information from the processing unit 320 and supply this information to components that are external to the server 300. The information provided by the processing unit 320 to the supply unit 330 includes compliance check data, knife use information, knife durability parameters, additional information on the knife, device use information and grinding wheel information.

In addition to the information mentioned above, the information provided by the processing unit 320 to the supply unit 330 includes information on the activation of the device. The device activation information is information that allows the system of the present invention to define whether or not the user has activated the knife sharpening device. For the knife sharpening device to be used, this device must be activated by the user.

To activate the knife sharpening device, the user accesses the server in order to register. After registration, the user inserts the serial number of the knife sharpening device. This registration and activation are received by the server through the receipt and storage unit 310 user. This information is then transferred to the processing unit 320 and the supply unit 330.

In a preferred embodiment, the supply unit 330 is connected not only to the processing unit 320, but also to the knife sharpening device. Consequently, the supply unit 330 is configured to send information to the knife sharpening device.

In a preferred embodiment, the information sent to the knife sharpening device includes: the device activation information.

With regard to the device activation information, the knife sharpening device 200 is configured to be activated through a registry of that reference number of the knife sharpening device 200 with a user account on the server 300. When the knife sharpening device 200 reference number is registered with the user account, the knife sharpening device 200 is activated. To approve the use of the knife sharpening device 200, the server 300 sends the device activation information to the knife sharpening device. Without the registration information forwarded by the server 300 to the knife sharpening device 200, the control board 212 prevents the use of the knife sharpening device 200. To do so, the control board 212 is configured to prevent the operation of the knife sharpening device 200 components, such as the motor 204, for example.

In an alternative embodiment, the information sent to the knife sharpening device includes: compliance check data and the knife durability parameters, in addition to the device activation information.

In an alternative embodiment, the compliance check data is sent to the knife sharpening device to prevent the use of the knife sharpening device. In this case, if the compliance check data shows that the knife use information is non-compliant with the knife use parameters, the knife sharpening device control board processes this information and prevents the knife sharpening device from operating. One type of control board ensures that the knife sharpening device does not operate, by stopping the motor, for example.

Alternatively, the device may advise the user that the compliance check data indicates that the knife use information is non-compliant with the knife use parameters, by through the signaling element.

In an alternative embodiment, the knife durability parameters are sent to the knife sharpening device whereby the compliance check data is generated in real time. In this case, when the communication antenna 210 of the knife sharpening device obtain the knife use information, the control board 212 checks whether the knife use information is non-compliant with the knife use parameters fool that knife. Should the knife use information not be compliant with the knife use parameters for that knife, the knife sharpening device may supply this information through the signaling element, or else haunted separations so that the sharpening operation does not occur for that knife.

This alternative configuration is particularly useful when the connection of the sharpening device with the server 300 is not secure and the knife sharpening device may sometimes be offline. Consequently, generating the compliance check data in real time on the actual device is advantageous.

In a preferred embodiment, the supply unit 330 is also connected to a knife use database 400. The knife use database 400 is an external component of the server 300 that receives the knife use information collected by the server 300 from the supply unit 330. The knife use database 400 is configured to obtain such information and store it.

The knife use information stored in the knife use database 400 is used to identify the need to adjust the knife durability parameters. This the knife replacement.

The effects attained by this characteristic are: more accurate definition of the ideal moment for knife replacements and better user safety.

An example of recurrence for adjusting knife durability parameters, which must be used only as exemplification in this invention, and may not be used restrictively, occurs when a value between two and one hundred knives of the same model present knife use information that does not comply with the knife durability parameters, users nevertheless decide to continue using the knives. This decision on use may be due to a variety of factors that are beyond the scope of this invention. When users decide to continue using a knife with knife use information that is not compliant with the knife durability parameters, this information is transferred from the knife sharpening device to the receipt and storage unit 310, and then to the processing unit 320, the supply unit 330 and then to the knife use database 400.

The knife use information stored in the knife use database 400 is used to adjust the knife durability parameters, if necessary. To do so, the knife use information is used to generate parameter adjustment information. The parameter adjustment information is generated through the difference between the knife use information and the knife durability parameters.

In a preferred embodiment, the parameter adjustment information is defined manually by the operator 600, based on the knife use information in the knife use database 400 and the knife durability parameters. When the information stored in the knife use database 400 indicates that there is recurrent use of knives of the same model with knife use information that is not compliant with the knife durability parameters, the operator 600 receives this information, defines the parameter adjustment information and adjusts the knife durability parameters stored in the parameters supply unit 500, in order to increase the accuracy of the system.

Consequently, the knife durability parameters are defined according to the knife model and the type of abrasive and may be adjusted by the parameter adjustment information when necessary.

FIGS. 6 to 11 illustrate schematic diagrams of the knife replacement system 100 of the present invention according to alternative embodiments.

FIG. 6 presents an embodiment of the knife replacement system 100 of the present invention, wherein the knife use database 400 supplies knife use information directly to the parameters supply unit 500. In this embodiment, the adjustment of the knife durability parameters is performed automatically in the parameters supply unit 500 with no need for adjustment by the operator 600. The parameters supply unit 500, however, allows the operator 600 to alter the knife durability parameters, if necessary. Furthermore, the parameters supply unit 500 continues to obtain the knife durability parameters from the operator 600, as defined by the knife model and type of abrasive.

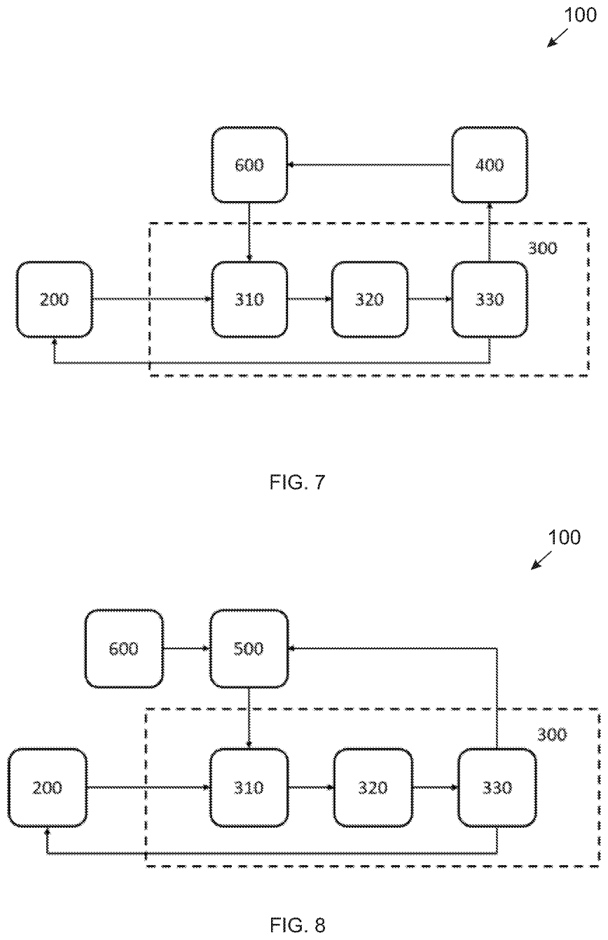

FIG. 7 presents an embodiment of the knife replacement system 100 of the present invention, wherein the receipt and storage unit 310 of the server 300 receives the knife durability parameters directly from the operator 600. In this embodiment, the operator 600 receives the knife use information from the knife use database 400 for any possible adjustments that may be required. The adjustment of the knife durability parameters, if necessary, is performed by the operator 600, which then provides the knife durability parameters, adjusted or not, to the receipt and storage unit 310 of the server 300.

FIG. 8 presents an embodiment of the knife replacement system 100 of the present invention, wherein the parameters supply unit 500 is connected to the supply unit 330 and to the receipt and storage unit 310 of the server 300. In this embodiment, the supply unit 330 supplies knife use information directly to the parameters supply unit 500. The adjustment of the knife durability parameters is performed automatically in the parameters supply unit 500, with no need for adjustment by the operator 600. However, the parameters supply unit 500 allows the operator 600 to alter the knife durability parameters, if necessary. Furthermore, the parameters supply unit 500 receives the knife durability parameters from the operator 600, whereby the knife durability parameters supplied to the parameters supply unit 500 are defined by the knife model and type of abrasive.

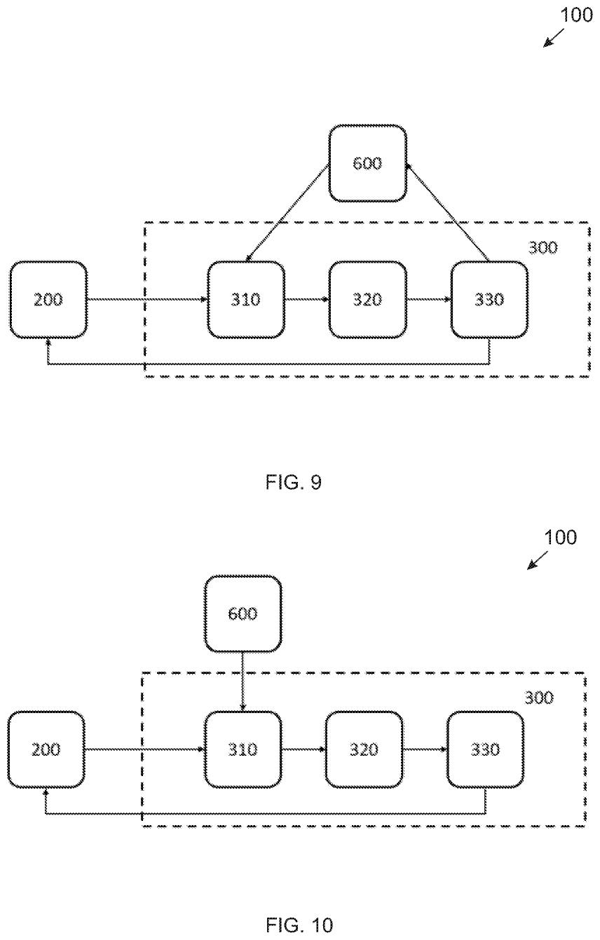

FIG. 9 presents an embodiment of the knife replacement system 100 of the present invention, wherein the operator 600 supplies the knife durability parameters directly to the receipt and storage unit 310. In this embodiment, the knife use information is provided by the supply unit 330 directly to the operator 600, which must then adjust the knife durability parameters, if necessary. Consequently, the operator 600 defines the knife durability parameters according to the knife model and the type of abrasive and adjusts the durability parameters based on the knife use information from the supply unit 330 when necessary.

FIG. 10 presents an embodiment of the knife replacement system 100 of the present invention, wherein the operator 600 supplies the knife durability parameters directly to the receipt and storage unit 310. In this embodiment, the knife use information is not used to adjust the knife durability parameters. The knife durability parameters supplied to the receipt and storage unit 310 are defined on the basis of the knife model and the type of abrasive used.

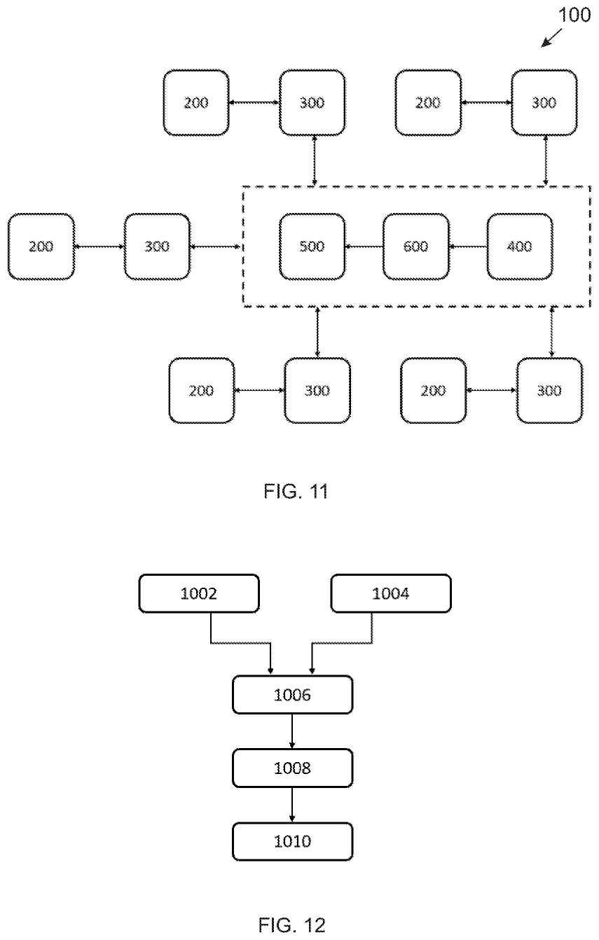

FIG. 11 presents an embodiment of the knife replacement system 100 of the present invention, wherein a plurality of knife sharpening devices and a plurality of servers 300 are connected into an assembly that comprises a knife use database 400, an operator 600 and parameters supply unit 500. In this case, the knife use database 400 receives a plurality of knife use information from the plurality of servers 300. Similarly, the parameters supply unit 500 supplies the knife durability parameters to the plurality of servers 300.

In additional embodiments, and plurality of knife sharpening devices 200 is connected a server 300 that is in turn connected to the assembly comprising a knife use database 400, an operator 600 and parameters supply unit 500.

FIG. 12 presents a sequence of steps for the knife replacement method according to a preferred embodiment of this invention.

The knife replacement method comprises a step of obtaining the knife durability parameters 1002 in the server 300. In a preferred embodiment, the knife durability parameters are defined periodically. Furthermore, the knife durability parameters are defined according to the knife model and the type of abrasive used in the sharpening. Additionally, the knife durability parameters are adjusted by the parameter adjustment information when necessary. The parameter adjustment information is generated through the difference between the knife use information and a plurality of knives of the same model from previous sharpening operations, and the knife durability parameters.

As already mentioned, the knife durability parameters comprise at least one of: the useful knife life duration and the maximum number of knife sharpening operations.

The step of obtaining the knife durability parameters 1002 in the server 300 may occur at different frequencies. A preferred frequency for defining the knife durability parameters is a daily frequency. However, other frequencies for defining the knife durability parameters may be used without affecting the purposes of this invention.

The knife replacement method also comprises a step of obtaining knife use information 1004 from the knife sharpening device 200, whereby the knife use information comprises at least one of: the knife use duration and number of knife sharpening operations. In a preferred embodiment, the step of obtaining knife use information 1004 is performed during a sharpening operation of the knife.

The steps of obtaining the knife durability parameters 1002 in the server 300 and obtaining knife use information 1004 from the knife sharpening device 200 may be performed in different orders, without affecting the final outcome of the method of the present invention.

The knife replacement method also comprises a step of defining the compliance check data 1006, wherein defining the compliance check data 1006 comprises comparing the knife use information with the knife durability parameters in order to define whether the knife use information is compliant with the knife durability parameters, or whether the knife use information is non-compliant with the knife durability parameters. As set forth in already described the knife use information is compliant with the knife durability parameters when ceiling values of the knife durability parameters are not exceeded by the knife use information values and the knife use information is non-compliant with the knife durability parameters when ceiling values of the knife durability parameters are exceeded by the knife use information values.

The step of defining the compliance check data 1006 is performed after the steps of obtaining the knife durability parameters 1002 from the server 300 and obtaining the knife use information 1004 from a knife sharpening device 200.

In a preferred embodiment, the step of defining the compliance check data 1006 is performed in the actual server 300 where the knife durability parameters are defined.

In an alternative embodiment, the step of defining the compliance check data 1006 is performed in real time on the knife sharpening device 200. In this case, the knife durability parameters are sent from the server 300 to the knife sharpening device 200, where they are stored.

Furthermore, the knife replacement method of the present invention comprises a step of replacing 1008 the knife with a replacement knife, should the knife use information present values not compliant with the knife durability parameter values.

The knife replacement method of the present invention may additionally comprise a step of notifying 1010 the user of the knife replacement with a replacement knife. This notification may be forwarded in different ways, such as through the user email registered in the server 300, for example.

The device, the system and the method described allow the replacement of a knife in a manner that provides gains in efficiency by suggesting replacement and/or replacing the knife at the right time, lowering costs by avoiding unnecessary replacements and with fewer user injuries, by suggesting replacement and/or replacing the knife when such replacement is necessary. These advantages may not be achieved through the developments described at the state of the art.

Having described one example of an embodiment, it must be understood that the scope of this invention encompasses other possible variations, being limited only by the content of the claims appendage hit two, including possible equivalents.

1. A knife sharpening device, comprising:
a sharpening device body;
a motor attached to the sharpening device body;
a grinding wheel associated with the motor;
sharpening guides attached to the sharpening device body and positioned alongside the grinding wheel;
a control board connected to the motor; and
a communication antenna comprised in and in communication with the control board,
wherein the control board is configured to connect an external network to the sharpening device, wherein the control board is configured to obtain device use information through the activation of the motor and knife use information through the communication antenna, wherein the control board is configured to send the obtained knife use information to an external server if the control board is connected to the external network, wherein the control board is configured to store the obtained knife use information if the control board is not connected to the external network, and wherein the knife use information comprises at least one of: the knife use duration and number of knife sharpening operations.

2. The knife sharpening device, according to claim 1, further comprising a signaling element connected to the control board, wherein the signaling element is configured to receive the device use information from the control board and provide an user with the device use information, wherein the device use information comprises at least one from among: connection of the device to an energy source, connection of the device to an external network, internal problem with device components, collecting the use information, sending the knife use information to the server and activation of the device by the user through the external server.

3. The knife sharpening device, according to claim 1, wherein the control board is configured to store usage limits offline and halt the operations of the knife sharpening device should offline usage limit situations occur, wherein the offline usage limit situations occur when the knife sharpening device remains unconnected from the external network for a period of time longer than that defined in the offline usage limits or as from a number of sharpening operations higher than that defined in the offline usage limits.

4. The knife sharpening device, according to claim 3, wherein the offline usage limit situations occur when the knife sharpening device remains unconnected from the external network for a period of time longer than 30 (thirty) days, or when the knife sharpening device remains unconnected from the external network for more 4,000 (four thousand) sharpening operations.

5. A knife replacement method, comprising the steps of:
obtaining knife durability parameters, wherein the knife durability parameters comprise at least one of: useful knife life duration and maximum number of knife sharpening operations;
obtain knife use information using the knife sharpening device according to claim 1, wherein the knife use information comprises at least one of: knife use duration and number of knife sharpening operations;
defining compliance check data, wherein defining the compliance check data comprises comparing the knife use information with the knife durability parameters in order to define whether the knife use information is compliant with the knife durability parameters, or whether the knife use information is non-compliant with the knife durability parameters; and
replacing the knife with a replacement knife, should the knife use information present values not compliant with the knife durability parameter values.

6. The knife replacement method, according to claim 5, wherein the step of defining the knife durability parameters takes place on a daily basis.

7. The knife replacement method, according to claim 5, wherein the knife durability parameters are adjusted by a parameter adjustment information, wherein the parameter adjustment information is generated through the difference between the knife use information on previous sharpening operations, and the knife durability parameters.

8. The knife replacement method, according to claim 5, further comprising a step of notifying a user about replacing the knife with a replacement knife.

9. Knife A knife replacement system, comprising:
the knife sharpening device according to claim 1; and
a server, wherein the server is configured to:
obtain the knife durability parameters, wherein the knife durability parameters are defined periodically according to the knife model, and wherein the knife durability parameters comprise at least one of: useful knife life duration and maximum number of knife sharpening operations;
obtain knife use information from the knife sharpening device, wherein the knife use information comprises at least one of: knife use duration and number of knife sharpening operations;
compare the knife use information with the knife durability parameters; and
suggest the knife replacement with a replacement knife, should the knife use information present values not compliant with the knife durability parameter values.

10. The knife replacement system according to claim 9, wherein the definition of the knife durability parameters takes place on a daily basis.

11. The knife replacement system, according to claim 9, wherein the knife durability parameters are adjusted by the parameter adjustment information, wherein the parameter adjustment information is generated through the difference between the knife use information and the knife durability parameters from previous sharpening operations.
